(19) United States
(12) Patent Application Publication
(10) Pub. No.: US 2011/0052985 A1
(43) Pub. Date: Mar. 3, 2011

(54) ELECTRODE STRUCTURE AND ELECTRIC ENERGY STORAGE DEVICE

(75) Inventors: Akio Kashiwazaki, Yokohama-shi (JP); Soichiro Kawakami, Machida-shi (JP)

(73) Assignee: CANON KABUSHIKI KAISHA, Tokyo (JP)

(21) Appl. No.: 12/940,758

(22) Filed: Nov. 5, 2010

Related U.S. Application Data
(63) Continuation of application No. PCT/JP2010/004126, filed on Jun. 21, 2010.

(30) Foreign Application Priority Data
Jun. 23, 2009 (JP) 2009-149192

(51) Int. Cl. H01M 4/40; H01M 4/58; H01M 4/62; H01M 4/48

(52) U.S. Cl. 429/217; 429/218.1; 429/231.95

(57) ABSTRACT

Provided is an electrode structure having a high power density and being superior in repetitive charge/discharge efficiency and an electric energy storage device using the electrode structure. The electrode structure includes an electrode material layer including an electrode material including active material particles containing at least one of silicon, tin and alloys containing at least one of them, and a binder binding the active material particles, the binder has the following characteristics: tensile modulus: 2000 MPa or more, breaking strength: 100 MPa or more, break elongation: 20% to 120% and the ratio of breaking strength/break elongation >1.4 (MPa/%), and an average particle size of the particles is 0.5 μm or less, the electrode structure has a maximum thermal history temperature less than 350° C. and lower than the glass transition temperature of the binder. The electric energy storage device uses, as its negative electrode, the electrode structure.

### CROSS-REFERENCE TO RELATED APPLICATIONS

This application is a continuation of International Application No. PCT/JP2010/004126, filed Jun. 21, 2010, which claims the benefit of Japanese Patent Application No. 2009-149192, filed Jun. 23, 2009.

### BACKGROUND OF THE INVENTION

1. Field of the Invention

The present invention relates to an electrode structure which has a high power density, is superior in repetitive charge/discharge efficiency and can store and emit lithium ions. The present invention also relates to an electric energy storage device provided with the electrode structure.

2. Description of the Related Art

An electric energy storage device that has a high power density and that is superior in repetitive charge/discharge efficiency has long been demanded.

A lithium secondary battery utilizing silicon, tin or their alloys as an active material for an electrode structure of its negative electrode has, in spite of its high power density, the problem that an increase in internal resistance along with the volumetric expansion and shrinkage of the electrode material during charging/discharging causes deterioration of charge/discharge efficiency.

A binder, which is a component constituting the electrode structure, have been studied as one of means taken to solve this problem.

WO2004/004031 discloses an electrode structure using a silicon or tin element having a particle size of 0.8 μm as the active material in which the binder has the following defined characteristics: breaking strength: 50 MPa or more, break elongation: 10% Or more, tensile modulus: 10000 MPa or less and thermal history temperature (baking temperature): higher than the glass transition temperature of the binder.

### SUMMARY OF THE INVENTION

According to the technologies described in Patent Literature 1, since the thermal history temperature is high and therefore, the growth of crystals of silicon or tin is accelerated with the result that an increase in a particle size, a reduction in capacity caused by the increased particle size and a deterioration of charge/discharge efficiency are easily caused. Also, at high thermal history temperature, oxidation of oxygen and water stuck to the crystals is easily caused during the course of the process, with the result that the amount of an oxide of silicon or tin to be produced is increased, leading to a fast deterioration in charge/discharge efficiency.

It is an object of the present invention to solve the problem, and to provide an electrode structure which has a high power density and is superior in repetitive charge/discharge efficiency, and to provide an electric energy storage device using the electrode structure.

### Solution to Problem

The problem is solved by an electrode structure according to the present invention, the electrode structure being provided with an electrode material layer including an electrode material including active material particles containing at least one type selected from the group consisting of silicon, tin and alloys containing at least one of silicon and tin, and a binder which binds the active material particles, wherein the binder has the following characteristics: tensile modulus: 2000 MPa or more, breaking strength: 100 MPa or more, break elongation: 20% or more and 120% or less and the ratio of breaking strength/break elongation >1.4 (MPa/%), and the active material particles have an average particle size of 0.5 μm or less, the electrode structure being produced by baking the electrode material and having a maximum thermal history temperature less than 350° C. and lower than the glass transition temperature of the binder.

Also, an electric energy storage device which solves the problem includes a negative electrode using the electrode structure, a lithium ion conductor and a positive electrode, the device utilizing an oxidation reaction of lithium and a reducing reaction of lithium ions.

In the present invention, the electric energy storage device conceptually includes capacitors, secondary batteries, devices obtained by a combination of a capacitor and secondary battery, or devices obtained by incorporating a generating electricity mechanism in these devices.

### ADVANTAGEOUS EFFECTS OF INVENTION

The present invention can provide an electrode structure which has a high power density and is superior in repetitive charge/discharge efficiency, and an electric energy storage device using the electrode structure.

According to the present invention, in particular, the mechanical properties and heat treating temperature of the binder as a structural element of the electrode structure are defined, and the breakage of the electrode caused by the expansion and shrinkage of the active material particles can be reduced within the defined range. As a result, the electric energy storage device using the electrode structure of the present invention can limit the increase in internal resistance caused by the repetition of charge/discharge operations, thereby the repetitive charge/discharge efficiency can be improved. This effect is significant especially when the particle size of the active material particle is reduced to improve the power density.

Further features of the present invention will become apparent from the following description of exemplary embodiments with reference to the attached drawings.

### BRIEF DESCRIPTION OF THE DRAWINGS

FIG. 1 is a typical view showing an embodiment of an electrode structure according to the present invention.

FIG. 2 is a typical view showing another embodiment of an electrode structure according to the present invention.

FIG. 3 is a typical sectional view showing an example of an electrode structure according to the present invention.

FIG. 4 is a conceptual sectional view showing an example of an electric energy storage device according to the present invention.

FIG. 5 is typical cell sectional view showing a monolayer flat type (coin type) electric energy storage device.

FIG. 6 is typical cell sectional view showing a spiral cylindrical type electric energy storage device.

FIG. 7 is a graph showing the relation between the tensile modulus of each binder in a part of Examples of the present invention and the ratio of the amount (quantity of electricity) of Li to be emitted at 10th cycle to that at 1st cycle.

FIG. 8 is a graph showing the relation between the tensile modulus of each binder in a part of Examples of the present invention and the ratio of the amount (quantity of electricity) of Li to be emitted at 50th cycle to that at 10th cycle.

FIG. 9 is a graph showing the relation between the breaking strength of each binder in a part of Examples of the present invention and the ratio of the amount (quantity of electricity) of Li to be emitted at 10th cycle to that at 1st cycle.

FIG. 10 is a graph showing the relation between the breaking strength of each binder in a part of Examples of the present invention and the ratio of the amount (quantity of electricity) of Li to be emitted at 50th cycle to that at 10th cycle.

FIG. 11 is a graph showing the relation between the break elongation of each binder in a part of Examples of the present invention and the ratio of the amount (quantity of electricity) of Li to be emitted at 10th cycle to that at 1st cycle.

FIG. 12 is a graph showing the relation between the breaking strength of each binder in a part of Examples of the present invention and the ratio of the amount (quantity of electricity) of Li to be emitted at 50th cycle to that at 10th cycle.

FIG. 13 is a graph showing the relation between the ratio of breaking strength/break elongation of each binder in a part of Examples of the present invention and the ratio of the amount (quantity of electricity) of Li to be emitted at 10th cycle to that at 1st cycle.

FIG. 14 is a graph showing the relation between the ratio of breaking strength/break elongation of each binder in a part of Examples of the present invention and the ratio of the amount (quantity of electricity) of Li to be emitted at 50th cycle to that at 10th cycle.

### DESCRIPTION OF THE EMBODIMENTS

Preferred embodiments of the present invention will now be described in detail in accordance with the accompanying drawings.

An embodiment according to the present invention will be explained in detail.

An electrode structure according to the present invention is provided with an electrode material layer that has an electrode material including active material particles containing at least one type selected from the group consisting of silicon, tin and alloys containing at least one of silicon and tin, and a binder which binds the active material particles, in which the binder has the following characteristics: tensile modulus: 2000 MPa or more, breaking strength: 100 MPa or more, break elongation: 20% or more and 120% or less and the ratio of breaking strength/break elongation >1.4 (MPa/%), and the active material particles have an average particle size of 0.5 μm or less, the electrode structure being produced by baking the electrode material and having a maximum thermal history temperature less than 350° C. and lower than the glass transition temperature of the binder.

Electrode Structure

The embodiment of the electrode structure of the present invention will be explained with reference to the drawings.

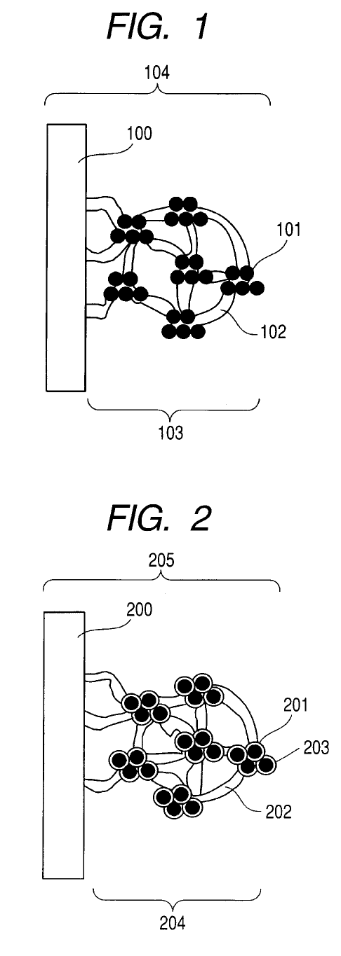

FIG. 1 is a typical view showing an embodiment of the electrode structure of the present invention and shows the relation between active material particles, a binder and a current collector. In FIG. 1, an electrode structure 104 shown in FIG. 1 is provided with a current collector 100 and an electrode material layer 103. This electrode material layer 103 is constituted of an electrode material including active material particles 101 containing at least one type selected from the group consisting of silicon, tin and alloys containing at least one of silicon and tin and a binder 102 that binds the active material particles 101 among them. The electrode material layer may contain other conductive auxiliary material.

Also, the active material particles 101 used in the electrode structure of the present invention may be secondary particles constituted of plural primary particles.

FIG. 2 is a typical view showing another embodiment of the electrode structure of the present invention and is a typical view showing the relation between active material particles 201 having a surface layer, a binder 202, an electrode material layer 204 and a current collector 200. An electrode structure 205 shown in FIG. 2 is different from the electrode structure 104 shown in FIG. 1 in the structure of the active material particles 201 and is the same as the electrode structure 104 except for the structures. The active material particles 201 are provided with a surface layer 203 containing a metal oxide on its surface. The term “metal oxide” in the present invention and in the specification conceptually may include oxides of semimetals.

(Outline of the Structure of the Electrode Structure)

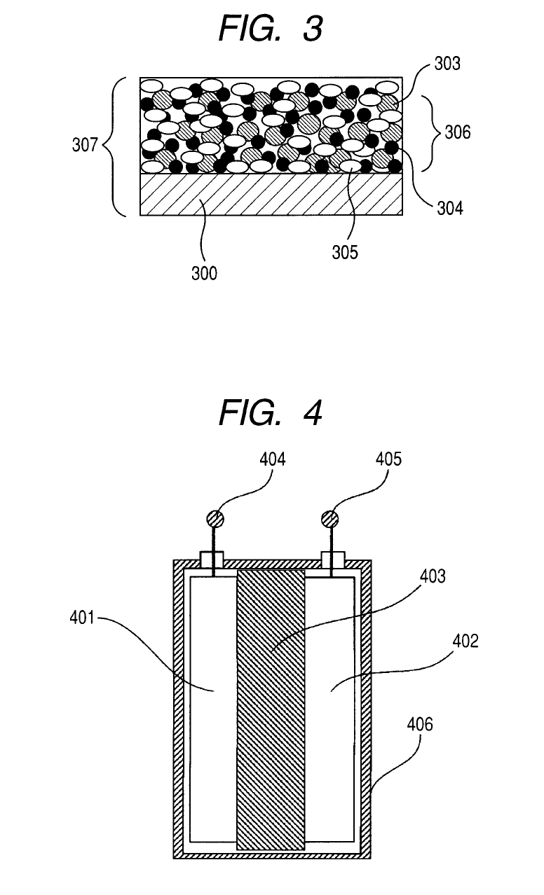

FIG. 3 is a schematic sectional and structural view of an embodiment of the electrode structure of the present invention. The structure in FIG. 3 is shown to have a configuration closer to an actual one than those in FIGS. 1 and 2.

In FIG. 3, the symbol 300 represents a current collector, the symbol 303 represents active material particles, the symbol 304 represents a conductive auxiliary material, the symbol 305 represents a binder, the symbol 306 represents an electrode material layer and the symbol 307 represents an electrode structure. The electrode structure of the present invention is characterized by the feature that the tensile modulus, breaking strength, break elongation, ratio of breaking strength/break elongation of each of the binders 102, 202 and 305 in the electrode material layers 103, 204 and 306, the maximum heat history temperature of each of the electrode structures 104, 205 and 307 and the average particle size of each of the active material particles 101, 201 and 303 respectively fall in a specific range.

(Mechanical Properties)

The tensile modulus, breaking strength, break elongation, ratio of breaking strength/break elongation (these values are generically called “mechanical properties) of each of the binders 102, 202 and 305 will be explained.

First, the tensile modulus of each of the binders 102, 202 and 305 is 2000 MPa or more. This tensile modulus is desirably 2100 MPa or more and 10000 MPa or less. When the tensile modulus of each of the binders 102, 202 and 305 which bind the active material particles 101, 201 and 303 respectively is higher, the whole deformation of each of the electrode material layers 103, 204 and 306 can be more reduced when the active material particles 101, 201 and 303 are expanded or shrunk in charge/discharge operations. Therefore, the adhesion between the electrode material layers 103, 204 and 306 and the current collectors 100, 200 and 300 and the contact conditions among active material particles 101, 201 and 303 can be well maintained. When the tensile modulus is less than 2000 MPa, the deformation of the electrode material layer against the stress produced when the electrode is expanded or shrunk is increased and it is therefore difficult to keep high adhesion between the electrode material layer and the current collector and good contact condition among the active material particles.

Also, the breaking strength of each of the binders 102, 202 and 305 is 100 MPa or more. This breaking strength is desirably 110 MPa or more and 400 MPa or less. When the breaking strength of the binder is less than 100 MPa, the electrode material layers 103, 204 and 306 are easily broken or easily peeled from the current collectors 100, 200 and 300 of the electrode material layers 103, 204 and 306 respectively when the stress produced by the expansion or shrinkage of the active material particles 101, 201 and 303 is applied.

The break elongation of each of the binders 102, 202 and 305 is 20% or more and 120% or less. This break elongation is desirably 30% or more and 110% or less. When the break elongation of the binder is less than 20%, it cannot stand against the expansion of the active material particles 101, 201 and 303 when the battery is charged, that is, when Li is inserted, with the result that the electrode material layers 103, 204 and 306 are themselves broken, the contact conditions among the active material particles 101, 201 and 303 are impaired, and the electrode material layers 103, 204 and 306 are easily peeled from the current collectors 100, 200 and 300 respectively. Also, when the break elongation exceeds 120%, the electrode material layers 103, 204 and 306 are stretched following the expansions of the active material particles 101, 201 and 303, causing an easy occurrence of the phenomenon that the distances among the active material particles 101, 201 and 303 are spaced apart, and hence the resistances of the electrode structures 104, 205 and 307 are easily increased.

Also, there is the following relation between the breaking strength and break elongation of each of the binders 102, 202 and 305: the ratio of breaking strength/break elongation >1.4 (MPa/%). It is desirable that the ratio of breaking strength/break elongation >1.8 (MPa/%). When the ratio of breaking strength/break elongation is 1.4 (MPa/%) or less, the electrode material layers 103, 204 and 306 are easily peeled from the current collectors 100, 200 and 300 even in the case where the binder is made of a material having a high breaking strength.

Next, the definitions of the mechanical properties in the present invention will be explained.

In the case, like a metal, where a proportional relation is kept between the stress and strain (elongation) of the binder in the first stage when a tensile load is applied, the Hooke's law is applicable and the tensile modulus is calculated by the following equation.

E=σ/ε

where E: tensile modulus [MPa], ν: breaking strength [MPa] and ε: break elongation [%].

However, such a proportional relation is not generally kept in the case of a plastic. Therefore, JIS K7113 and JIS K7161-1994 translated from ISO527-1 as it is are established.

In more detail, in the case where no proportional relation is kept, the tensile modulus is calculated by the following equation based on two defined strain values on a tensile stress-strain curve.

Et=(σ2−σ1)/(ε2−ε1)

where Et: tensile modulus [MPa], σ1: tensile stress [MPa] when the strain ε1=0.0005 and σ2: tensile stress [MPa] when the strain ε2=0.0025.

The breaking strength is also called “tensile stress” and calculated by the following equation.

σ=F/A

Where σ: breaking strength [MPa], F: measuring load [N], A: initial cross-section area of a test specimen [mm²] and Pa=N/m².

The break elongation is also called tensile strain. The break elongation ε is calculated by the following equation.

ε=ΔL0/L0

where ε: break elongation [%], L0: distance between bench marks of a test specimen [mm] and ΔL0: increase in the distance between bench marks of a test specimen [mm]. These breaking strength and break elongation are measured by the method described in JIS K6782.

(Maximum Thermal History Temperature)

The maximum thermal history temperature of each of the electrode structures 104, 205 and 307 will be explained.

The maximum thermal history temperature means the highest heat treating temperature when an electrode material is baked to form an electrode material layer.

In the present invention, the maximum thermal history temperature of the electrode structure produced by baking the electrode material is less than 350° C. When the maximum thermal history temperature is 350° C. or more, the growth of crystals of silicon and tin that constitute the active material particles is promoted, resulting in increased particle size, in restriction on high capacity caused by the increased particle size, and in deterioration in repetitive charge/discharge efficiency. Moreover, the maximum thermal history temperature of the electrode structure is designed to be lower than the glass transition temperature of the binder in consideration of an influence on the binder. Also, it is more preferable that the maximum thermal history temperature of the electrode structure be designed to be less than 250° C.

At this time, when the thermal history temperature is higher, silicon and tin that are the active materials react with oxygen or water contained in the electrode material layer to promote the oxidation of silicon and tin, particles of silicon and tin those are micronized active materials are increased in size, and their crystallites are also increased in size. When particularly, the curing temperature is 350° C. or more, there is a tendency that the shrinkage of the electrode material is increased as the binder is cured, and the electrode material layer is hardened and becomes fragile.

With the use of the binder mentioned above, a high capacity and an improvement in repetitive charge/discharge characteristics can be attained more efficiently.

(Active Material Particles)

In the present invention, the active material particles 101, 201 and 303 are a powder material containing at least one type selected from the group consisting of silicon, tin or alloys containing at least one of silicon and tin.

The active material particles 101, 201 and 303 preferably contain microcrystals of a metal having an eutectic composition of silicon or tin. The crystallite size of silicon or tin can be more reduced by adopting an eutectic composition. The crystallite size of microparticles of silicon or tin is preferably designed to be in a range from 1 to 30 nm. When the crystallite size is too large, a local reaction tends to take place in the case where the electrode is formed and lithium ions (hereinafter the lithium ion may be written simply as “lithium” or “Li”) are electrochemically inserted and released (insertion and emission), causing a reduction in the life of the electrode. When the crystallite size is too small, resistance of the electrode is increased. The average particle size of the powder material (of secondary particles when plural primary particles are collected to form secondary particles) is 0.5 μm or less as mentioned above and preferably 0.2 μm or less. As examples of this reason, the following points are given. First, a particle size of 0.5 μm or less enables more uniform diffusion of lithium ions and therefore, the high capacity performance which is the feature of the active material particles can be sufficiently exhibited. Also, the generation of cracks of the active material particles caused by the expansion and shrinkage resulting from the insertion and emission of lithium ions is suppressed, leading to an improvement in cycle life. Also, a smoother electrode surface can be obtained.

In order to maintain the small particle size of such active material particles, it is also important to satisfy such a requirement that the maximum thermal history temperature is less than 350° C. and lower than the glass transition temperature of the binder, and preferably less than 250° C.

The material constituting the active material particles may be a composite with carbon. In this case, the ratio by weight of the carbon element complexed is preferably 0.05 or more and 1.0 or less based on the material.

When the active material particles (primary particles) 201 is provided with a surface layer 203 containing a metal oxide on its surface as shown in FIG. 2, an active material particle (secondary particles) contains, as its structural element, plural primary particles containing at least one type selected from the group consisting of silicon, tin and alloys containing at least one of silicon and tin. This primary particle is preferably constituted of a crystal particle having a diameter of 5 nm or more and 200 nm or less and which is provided with an amorphous surface layer 203 having a thickness of 1 nm or more and 10 nm or less. Also, the metal oxide contained in the surface layer 203 is preferably more thermodynamically stable than silicon oxide or tin oxide (Gibbs free energy produced when the metal constituting the metal oxide is oxidized is smaller than that produced when silicon or tin is oxidized).

Specific examples of the metal (including semimetals) constituting the metal oxide contained in the surface layer 203 include one or more types of metals selected from Li, Be, B, Mg, Al, Ca, Sc, Ti, V, Cr, Mn, Zn, Ga, Y, Zr, Nb, Mo, Ba, Hf, Ta, W, Th, La, Ce, Nd, Sm, Eu, Dy and Er. It is more preferable to use one or more types of metals selected from Li, Mg, Al, Ti, Y, Zr, Nb, Hf, Ta, Th, La, Ce, Nd, Sm, Eu, Dy and Er. Oxides of a transition metal element selected from W, Ti, Mo, Nb and V and lithium-transition metal oxides are materials which enable intercalation or de-intercalation of lithium, allow lithium ions to diffuse speedily and is reduced in volumetric expansion even when lithium ions are intercalated. Among the metal elements, the most preferred examples of the element include Zr and Al in consideration of stability in air and handling easiness. Oxides of Zr or Al are chemically stable. Particularly, Al is more preferable because it has a lower melting point, forms an oxide more easily and is more inexpensive than Zr.

The present invention produces its effect more efficiently by using the active material particles 201 each provided with the surface layer 203 containing a metal oxide. This is because this metal oxide has the ability to prevent oxidations of silicon or tin.

Single microparticles of silicon, tin or their alloys are easily oxidized because these compounds are reacted with oxygen and water in the atmosphere (for example, air) during the course of the process of making an electrode or after the process.

When the average particle size of the active material particles is 0.5 μm or less, in particular, they have a large surface area and hence a large reaction area, and therefore, or water intermixed with these active material particles during the process of making an electrode to form an oxide of silicon or tin. When silicon or tin is oxidized, there is the problem that the storage capacity is dropped, resulting in deterioration in charge/discharge efficiency, when the active material particles are incorporated into the electric energy storage device.

The metal oxide in the surface layer can prevent oxidation of silicon and tin, thereby such a problem can be prevented from arising. Specifically, because the active material particle is coated with a surface layer containing a metal oxide, oxidation is limited, which makes easy to handle the active material particles in the electrode production process and subsequent steps. Also, even in the case where the active material particles are stored for a long period of time, they are almost not chemically changed and are stable and can therefore exhibit stable performance when they are used for the electrode material of the electric energy storage device. This effect of limiting oxidation is more significant when the average particle size of the active material particles is 0.2 μm or less.

It is also preferable, from the viewpoint of obtaining a high output capacity and a high repetitive charge/discharge efficiency, that the content of the active material particles 101 and 102 which are contained in the electrode material constituting the electrode material layer 103 and which are constituted of at least one type selected from the group consisting of silicon, tin and alloys containing at least one of silicon and tin be in a range from 30% by weight to 98% by weight and preferably 50% by weight to 90% by weight based on the electrode material.

(Method of Preparing the Active Material)

Preferable examples of the method of preparing the active material particles include milling using, for example, ball mills such as a direct planetary ball mill, vibration ball mill, conical mill and tube mill, media mills such as an attritor type, sand grinder type, annular mill type and tower mill type or beads mill. Also, the method in which a slurry obtained by dispersing a raw material is made to collide with under high pressure to obtain active material particles having a desired particle size can be preferably used. Using these methods, the active material particles are prepared so as to have a desired size.

Also, when the amorphous surface layer essentially consisting of a metal oxide is formed on the primary particles containing silicon, tin or an alloy containing at least one of silicon and tin, the methods given below are preferably applied. Silicon, tin or an alloy containing at least one of silicon and tin may be mixed with a metal and melted to form a molten bath, followed by quickly cooling the molten bath by the atomization method (spraying method), gun method, single roll method or twin roll method to obtain a powder or ribbon-like material. With regard to the material obtained in this manner, the method is used so as to have a desired a particle size, thereby adjusting the particle size of a primary particle. An amorphous surface layer may be further formed on the primary particle obtained in this manner, by a method, for example, the heat plasma method or discharge plasma sintering method.

Binder

Any material may be used as the material used for the binder in the present invention without any particular limitation insofar as it has given mechanical properties. Preferable examples of the binder material include organic polymer materials, for example, fluororesins such as polyethylene tetrafluoride and polyvinylidene fluoride, polyamide imide, polyimide, styrene-butadiene rubber, modified polyvinylalcohol type resin reduced in water-absorbing ability, polyacrylates type resin and polyacrylates type resin-carboxymethyl cellulose.

Among these materials, particularly a polyimide or polyamide imide is preferable. As is usually known, a polyimide or polyamide imide is a material which is very tough and has high flexibility, can be processed into a film and is therefore considered to be most suitable as the electrode structure material.

The content of the binder in the electrode material is preferably 2% by weight or more and 30% by weight or less and more preferably 5% by weight or more and 20% by weight or less from the viewpoint of maintaining the binding force between the active material particles even if charge/discharge operations are repeated and also from the viewpoint of developing the performance of the negative electrode storing a larger quantity of electricity.

The electrode structure preferably contains the active material particles, binder and further, a conductive auxiliary agent.

Conductive Auxiliary Material

As the conductive auxiliary material to be used in the electrode material layer, carbon materials, for example, amorphous carbon such as acetylene black and KETJEN BLACK, graphite structure carbon, carbon nano-fiber and carbon nano-tube can be preferably used. Further, nickel, copper, silver, titanium, platinum, cobalt, iron, chromium or the like may be used as the conductive auxiliary material. The carbon material are preferable because it can retain the electrolyte solution and has a high specific surface area. As the shape of the conductive auxiliary material, a shape selected from a sphere form, flake form, filament form, fiber form, spike form, and needle form may be adopted. When two or more powders each having a different shape are adopted, the packing density of the electrode material layer can be increased to thereby reduce the electric resistance (impedance) of the electrode structure.

The average particle size of particles (secondary particles) of the conductive auxiliary material is preferably 0.5 μm or less and more preferably 0.2 μm or less. The average particle size of primary particles of the conductive auxiliary material is preferably in a range from 10 to 100 nm and more preferably in a range from 10 to 50 nm. The ratio by weight of the conductive auxiliary material to the binder is preferably in a range from 0.15 to 40, however it should be noted that the preferable range depends on the density of the conductive auxiliary material. When the average particle size of primary particles of the conductive auxiliary material is in a range from 10 to 100 nm, the ratio by weight of the conductive auxiliary material to the binder is more preferably in a range from 0.17 to 1.0.

Current Collector

The current collector used for the electrode structure of the present invention works to supply the current consumed in an electrode reaction in a charge operation efficiently or to collect the current generated in a discharge operation. When, particularly, the electrode structure is applied to the negative electrode of the electric energy storage device, a material which has a high electroconductivity and is inert to the electrode reaction of the electric energy storage device is desirable as the material used to form the current collector. Preferable examples of the material include those consisting of one or more metal materials selected from copper, nickel, iron, stainless steel, titanium, platinum and aluminum. Copper which is inexpensive and has a low electric resistance is used as a more preferable one. An aluminum foil having a high specific surface area may also be used. Although the current collector has a plate form, the term “plate form” is not limited in thickness within a practical range and includes the forms called “foil” having a thickness of about 5 μm to 100 μm. When a copper foil is used for the current collector, it is particularly preferably a copper foil which contains Zr, Cr, Ni, Si and the like arbitrarily and has high mechanical strength (high durability) because it is highly resistant to the repetitive expansion and shrinkage of the electrode layer in charge/discharge operations. Also, members which each have a plate form and also, a mesh, sponge or fiber form, punching metals, and metals and expand metals formed with a three-dimensional irregular pattern formed on each side thereof may be adopted. The plate or foil metals formed with a three-dimensional irregular pattern can be formed by applying pressure to a metal or ceramic roll formed with a microarray pattern or line/space pattern on its surface to transfer the pattern to a plate or foil metal. Particularly, an electric energy storage device adopting a current collector formed with a three-dimensional irregular pattern has the effects on a reduction in substantial current density per electrode area in charge/discharge operations, on an improvement in adhesion to the electrode layer, on an improvement in charge/discharge current characteristics due to an improvement in mechanical strength, and on an improvement in charge/discharge cycle life.

(Density of the Electrode Material Layer)

The density of the electrode material layer is preferably 0.5 g/cm³ or more and 3.5 g/cm³ or less.

The electrode structure of the present invention is used for the electrodes of electrochemical devices, and particularly, the electrodes of electric energy storage devices. Also, the electrode structure of the present invention can be preferably used in other applications including electrodes for electrolysis or for electrochemical synthesis.

Method of Making the Electrode Structure

The electrode structure of the present invention is made, for example, by the following procedures.

After a raw material including the active material particles, conductive auxiliary material and binder is adjusted to a desired particle size, these components are mixed and a solvent for the binder is properly added to prepare a slurry. The prepared slurry is applied to the surface of a current collector 300 by a well known coater and then, an electrode material layer 306 is baked according to a predetermined thermal history temperature (baking temperature). Thereafter, pressure is applied to the electrode material layer by a machine such as a roll press machine to adjust the electrode material layer to a desired thickness and density, to form an electrode structure 307.

After the viscosity of the slurry obtained in the procedures is adjusted, an electro-spinning device may be used to apply high voltage across a copper foil used as a current collector and a nozzle of the electro-spinning device to form an electrode material layer 306 on the current collector.

A more specific production method is as follows.

(1) A conductive auxiliary material powder and the binder component according to the present invention are mixed with a powder material as the active material and a solvent for the binder component is properly added to the mixture, which is then kneaded to prepare a slurry. In the case of positively forming voids in the electrode material layer, a foaming agent such as azodicarbonamide or P,P′-oxybisbenzenesulfonyldidrazide which generates nitrogen gas by the heating in the baking process may be added.

(2) The slurry is applied to the surface of the current collector to form an electrode material layer, followed by drying to form an electrode structure. Moreover, as mentioned above, the electrode structure layer is baked at a temperature less than 350° C. and lower than the glass transition temperature of the binder component and more preferably less than 250° C. and then the density and thickness of the electrode material layer are adjusted by a press machine.

(3) The electrode structure obtained in the (2) is appropriately cut to fit the housing of the electric energy storage device to arrange the shape of the electrode and an electrode tab for extracting current is formed by welding according to the need to make a negative electrode.

For example, the coater coating method or screen printing method may be applied as the coating method. Also, the powder material of the active material, conductive auxiliary material and binder component may be molded under pressure on the current collector without adding any solvent to form an electrode material layer. In this case, the density of the negative electrode material layer of the electric energy storage device of the present invention is preferably in a range from 0.5 to 3.5 g/cm³ and more preferably in a range from 0.9 to 2.5 g/cm³. When the density of the electrode material layer is too large, the expansion of the electrode material is too large when lithium is inserted, so that the electrode material layer is easily peeled from the current collector. Also, when the density of the electrode material layer is too small, the electric resistance of the electrode structure is too large, bringing about a reduction in charge/discharge efficiency and a large voltage drop when the battery is discharged.

Electric Energy Storage Device

The electric energy storage device according to the present invention is characterized by the feature that it is provided with a negative electrode using the electrode structure, a lithium ion conductor and a positive electrode and utilizes an oxidation reaction of lithium and a reducing reaction of lithium ions. The positive electrode is characterized by the feature that it is provided with a positive electrode active material layer and a current collector.

FIG. 4 is a typical view showing the basic structure of the electric energy storage device utilizing a redox reaction of lithium ions. In the electric energy storage device of FIG. 4, the symbol 401 represents a negative electrode, the symbol 403 represents a lithium ion conductor, the symbol 402 represents a positive electrode, the symbol 404 represents a negative terminal, the symbol 405 represents a positive terminal and the symbol 406 represents a battery case (housing).

When this electric energy storage device is made to charge, lithium ions reach the negative electrode 401 through the ion conductor 403 from the positive electrode 402 and are inserted into the active material of the negative electrode. When lithium ions are inserted into the active material, the volume of the active material is generally increased. If the electrode structure 307 of the present invention is used for the negative electrode 401, not only the deformation of the negative electrode caused by the increase in volume is reduced but also the problem as to an increase in contact resistance among the active material particles and an increase in contact resistance between the active material particles and the current collector which are caused by the deformation of the negative electrode can be reduced. As a result, the repetitive charge/discharge efficiency of the electric energy storage device having a high power density can be improved.

(Positive Electrode 402)

The positive electrode 402 is preferably constituted of a powder material consisting of transition metal compound particles selected from transition metal oxides, transition metal phosphoric acid compounds, lithium-transition metal oxides and lithium-transition metal phosphoric acid compounds, and conjugated with particles having an amorphous skin surface and an oxide including a metal oxide semimetal.

The positive electrode active material is essentially consisting of a transition metal compound selected from transition metal oxides, transition metal phosphoric acid compounds, lithium-transition metal oxides and lithium-transition metal phosphoric acid compounds or a carbon material. Further, the positive electrode active material is more preferably conjugated with an oxide or complex oxide which has an amorphous phase and contains, as its major component, an element selected from Mo, W, Nb, Ta, V, B, Ti, Ce, Al, Ba, Zr, Sr, Th, Mg, Be, La, Ca and Y. Moreover, the content of the conjugated oxide or complex oxide is preferably 1% by weight or more and 20% by weight or less based on the conjugated positive electrode active material and the rate of contribution of the oxide or complex oxide to the quantity of charge/discharge electricity is preferably 20% or less.

The positive electrode active material is preferably conjugated with a carbon material having a specific surface area ranging from 10 to 3000 m²/g.

The carbon material is preferably a carbon material selected from activated carbon, mesoporous carbon, carbon fiber and carbon nano-tube.

The crystallite size of the conjugated positive electrode active material is preferably 100 nm or less.

As an example of the method of producing the conjugated positive electrode material, a method is given in which a metal oxide material selected from transition metal oxides, transition metal phosphoric acid compounds, lithium-transition metal oxides and lithium-transition metal phosphoric acid compounds to be conjugated is mixed with an active material selected from transition metal oxides, transition metal phosphoric acid compounds, lithium-transition metal oxides and lithium-transition metal phosphoric acid compounds, to combine the both by mechanical milling using a mill such as a vibration mill or an attritor, thereby conjugating (mechanical alloying).

As to the positive electrode 402 which is to be a counter electrode of the electric energy storage device using, as its negative electrode, the active material of the present invention, there are the following three main cases.

(1) A crystalline lithium-transition metal oxide or lithium-transition metal phosphoric acid compound giving relatively flat potential in a discharge operation is used for the active material of the positive electrode to raise the energy density. As the transition metal element contained in the positive electrode active material, Ni, Co, Mn, Fe, Cr and the like are used more preferably as major elements.

(2) In the case of intending to more raise the power density than the case of the positive electrode of the (1), an amorphous transition metal oxide, transition metal phosphoric acid compound, lithium-transition metal oxide or lithium-transition metal phosphoric acid compound is used as the active material of the positive electrode. The crystallite size of the positive electrode active material is preferably 10 nm or more and 100 nm or less and more preferably 10 nm or more and 50 nm or less. As the transition metal element which is the major element of the positive electrode active material, an element selected from Mn, Co, Ni, Fe and Cr is more preferably used. It is inferred that because the positive electrode active material has small crystal particles and also, a large specific surface area, not only the intercalation reaction of lithium ions but also, the adsorption reaction of the surface of ions can be utilized, and the power density is more improved than that of the positive electrode of the (1). The positive electrode active material is preferably conjugated with an oxide or complex oxide containing an element selected from Mo, W, Nb, Ta, V, B, Ti, Ce, Al, Ba, Zr, Sr, Th, Mg, Be, La, Ca and Y as its major component. When, similarly to the case of the negative electrode active material, the positive electrode active material is conjugated with the oxide, crystal particles can be small-sized, thereby promoting the formation of amorphous material. In addition, carbon materials such as amorphous carbon, carbon nanofiber (carbon fiber of the nanometer order), carbon nano-tube, graphite powder are preferably conjugated with the positive electrode active material in order to promote the electroconductivity of the positive electrode active material.

(3) When it is desired to obtain a high power density, activated carbon, mesoporous carbon (carbon in which many meso-area pores are developed, and in other words, a carbon material provided with many meso-area holes), carbon nanofiber (carbon fiber of the nanometer order), carbon nano-tube, carbon material having a high specific surface area improved in specific surface area by, for example, pulverizing treatment and/or having many pores such as graphite, or metal oxide having a high specific surface area (containing an oxide of a semimetal) is used as the active material of the positive electrode. In this case, it is necessary to store lithium in the negative electrode or the positive electrode in advance when cells of the electric energy storage device are fabricated. As the method used to attain this, there is a method in which a lithium metal is brought into contact with the negative electrode or positive electrode to develop short circuits, thereby introducing lithium or introducing lithium in the form of a lithium-metal oxide or lithium-semimetal oxide in the active material.

The power density can be further improved by increasing the porosity of the positive electrode active material. Furthermore, the material of the (3) may be conjugated. When lithium which can be de-intercalated is not contained in the positive electrode active material, it is necessary to store lithium in the negative electrode or positive electrode by, for example, bringing metal lithium into contact with the negative electrode or positive electrode in advance same as (3). Also, the active material of each positive electrode of the (1), (2) and (3) can be conjugated with a polymer, such as a conductive polymer, which can electrochemically store ions in the active material of the positive electrode.

(Positive Electrode Active Material)

As the crystalline lithium-transition metal oxide or lithium-transition metal phosphoric acid compound to be used for the positive electrode active material of the (1), oxides or phosphoric acid compounds of Co, Ni, Mn, Fe, Cr or the like which is a transition metal element usable for a lithium secondary battery can be used. The compound can be obtained by blending a lithium salt or lithium hydroxide and a salt of a transition metal in a given ratio (when a phosphoric acid compound is prepared, phosphoric acid or the like is added) to react the mixture at a temperature as high as 700° C. or more. Also, a micro-powder of the positive electrode active material can be obtained by using a method such as the sol-gel method.

As the positive electrode active material of the (2), lithium-transition metal oxides, lithium-transition metal phosphoric acid compounds, transition metal oxides and transition metal phosphoric acid compounds in which the transition metal element is Co, Ni, Mn, Fe, Cr, V or the like are used, and those having an amorphous phase having a small crystallite size are preferable. The transition metal oxide or transition metal phosphoric acid compound having an amorphous phase is obtained by forming amorphous compounds from crystalline lithium-transition metal oxides, lithium-transition metal phosphoric acid compounds, transition metal oxides or phosphoric acid compounds by mechanical milling using a planetary ball mill, vibration mill, attritor or the like. Using the mills, the raw materials may be directly mixed and mechanically alloyed, followed by appropriate heat treating to prepare amorphous lithium-transition metal oxides, lithium-transition metal phosphoric acid compounds, transition metal oxides or transition metal phosphoric acid compounds. Also, these amorphous compounds can also be obtained by thermally treating oxides obtained through a reaction in the sol-gel method from a solution of salts, complexes and alkoxides which are raw materials. Heat treatment carried out at a temperature exceeding 1000° C. reduces the pore volume of the transition metal oxide, which promotes crystallization, resulting in a reduction in specific surface area, causing a deterioration in the performance of charge/discharge characteristics at a high-current density. The crystallite size of the positive electrode active material is preferably 100 nm or less and more preferably 50 nm or less. A positive electrode more superior in the rate of intercalation and de-intercalation of lithium ions and in the rate of adsorption and emission of lithium ions is made from the positive electrode active material having such a crystallite size.

Examples of carbon having a high specific surface area and/or high porosity which is used as the positive electrode active material of the (3) include carbon materials obtained by carbonizing organic polymers in an inert gas atmosphere, and carbon materials obtained by treating the carbon materials by an alkali or the like to form pores. Mesoporous carbon may also be used which is obtained by inserting an organic polymer material into a mold which is made in the presence of an amphipatic surfactant and made of an oxide in which pores are oriented to carbonize the organic polymer material and by removing the metal oxide by means of etching. The specific surface area of the carbon material is preferably in a range from 10 to 3000 m²/g. Besides the carbon materials, transition metal oxides such as manganese oxide having a high specific surface area may also be used.

The positive electrode active material having a high energy density and a certain degree of power density of the present invention is formed of an active material selected from a lithium-transition metal oxide, lithium-transition metal phosphoric acid compound, transition metal oxide and transition metal phosphoric acid compound, in which the transition metal element is Co, Ni, Mn, Fe, Cr, V or the like, the particles having an amorphous phase are conjugated with an oxide or complex oxide containing an element selected from Mo, W, Nb, Ta, V, B, Ti, Ce, Al, Ba, Zr, Sr, Th, Mg, Be, La, Ca and Y as its major component, and the amount of the oxide or complex oxide added for conjugating is preferably in a range from 1% by weight to 20% by weight and more preferably in a range from 2% by weight to 10% by weight based on all the conjugated positive electrode active material. When the oxide or complex oxide to be conjugated is added in an amount exceeding the amount range, the electricity storage capacity of the positive electrode is reduced. The contribution of the oxide or complex oxide to the quantity of charge/discharge electricity is desirably 20% or less. The positive electrode active material can be reduced in particle size like the negative electrode material according to the present invention when it is conjugated. Therefore, the rate of utilization of the positive electrode active material in charge/discharge operations is raised and therefore, an electrochemical reaction in charge/discharge operations takes place more uniformly and more rapidly. As a result, the energy density and power density are both improved. Also, the oxide is desirably a lithium ion conductor such as complex oxides of lithium.

When the conjugation is performed, it is preferable to conjugate carbon material such as amorphous carbon, mesoporous carbon (carbon material having many meso-area holes), carbon nano-fiber (carbon fibers of the nanometer order) carbon nano-tube, or graphite improved in specific surface area by milling treatment or the like.

Moreover, two or more types of materials selected from the materials of the (1), (2) and (3) may be mixed in the positive electrode active material prior to use.

(Method for Making the Positive Electrode)

The positive electrode used in the electric energy storage device of the present invention is made by forming an electrode material layer (layer of positive electrode active material) on the current collector. As the positive electrode in the present invention, an electrode is used which is produced by adopting the positive electrode active material in place of the powder particle 303 of a material containing at least one type selected from the group consisting of silicon, tin or an alloy containing at least one of silicon and tin in the electrode structure 307 having the typical sectional structure of FIG. 3 which is used to explain the negative electrode.

The electrode structure used for the positive electrode is made by the following procedures.

(1) A conductive auxiliary material powder and a binder are mixed in the positive electrode material and a binder solvent is appropriately added to the mixture, which is then kneaded to prepare a slurry.
(2) The slurry is applied to the current collector to form an electrode material layer (active material layer), and dried to form an electrode structure. Further, the electrode structure is dried at a temperature range from 100 to 300° C. under reduced pressure according to the need and, then, the density and thickness of the electrode material layer are adjusted by a press machine.
(3) The electrode structure obtained in the (2) is cut to fit the housing of the electric energy storage device to arrange the shape of the electrode and an electrode tab for extracting current is formed by welding according to the need to make a positive electrode.

For example, the coater coating method or screen printing method may be applied as the coating method. Also, the positive electrode active material, conductive auxiliary material and binder may be molded under pressure on the current collector without adding any solvent to form an electrode material layer. The density of the positive electrode material layer of the present invention is preferably in a range from 0.5 to 3.5 g/cm³ and more preferably in a range from 0.6 to 3.5 g/cm³. The density of the electrode layer is set to a lower value for a high-power density electrode and to a higher value for a high-energy density electrode.

(Positive Electrode Conductive Auxiliary Material)

The same one as the conductive auxiliary material used for the electrode structure of the present invention may be used.

(Positive Electrode Current Collector)

As the positive electrode current collector in the present invention, the same one as the current collector used for the electrode structure according to the present invention may be used. As the specific material used to form the current collector, a material which has a high electroconductivity and is inert to an electrochemical reaction along with the charge/discharge of the electric energy storage device is desirable and examples of the current collector material include those constituted of one or more metal materials selected from aluminum, nickel, iron, stainless steel, titanium and platinum.

(Positive Electrode Binder)

As the positive electrode binder, the binder used in the electrode structure according to the present invention may be used in the same manner. It is however more preferable to use, as the binder component, a polymer material, for example, fluororesins such as a polyethylene tetrafluoride and polyvinylidene fluoride, styrene-butadiene rubber, denatured acryl resin, polyimide and polyamide imide which does not cover the total surface area of the active material so that the effective surface area for the reaction of the active material can be large. The content of the binder in the electrode material layer of the positive electrode is preferably 1 to 20% by weight and more preferably 2 to 10% by weight from the viewpoint of maintaining the binding strength of the binder to the active material even by repetitive charge/discharge operations to develop the performance of the positive electrode that stores a larger quantity of electricity.

(Ion Conductor 403)

As the ion conductor to be preferably used for the electric energy storage device of the present invention, a separator holding an electrolyte solution (electrolyte solution prepared by dissolving an electrolyte in a solvent), a solid electrolyte, a solidified electrolyte obtained by forming an electrolyte gel by using a polymer gel, a complex of a polymer gel and a solid electrolyte or an ionic conductor such as an ionic liquid may be used.

The conductivity of the ionic conductor used in the electric energy storage device of the present invention is preferably 1×10⁻³ S/cm or more and more preferably 5×10⁻³ S/cm or more at 25° C.

Examples of the electrolyte include salts of lithium ions (Li⁺) and Lewis acids ions (BF₄⁻, PF₆⁻, AsF₆⁻, ClO₄⁻, CF₃SO₃⁻ and BPh₄⁻ (Ph: a phenyl group)), mixtures of these salts and ionic liquid. The salts are desirably well dewatered and deoxygenated, for example, by heating under reduced pressure. Moreover, electrolytes prepared by dissolving the lithium salt in an ionic liquid may also be used.

As the electrolyte solvent, for example, acetonitrile, benzonitrile, propylene carbonate, ethylene carbonate, dimethyl carbonate, diethyl carbonate, ethylmethyl carbonate, dimethylformamide, tetrahydrofuran, nitrobenzene, dichloroethane, diethoxyethane, 1,2-dimethoxyethane, chlorobenzene, γ-butyrolactone, dioxolan, sulfolane, nitromethane, dimethyl sulfide, dimethylsulfoxide, methyl formate, 3-methyl-2-okidazolidinone, 2-methyltetrahydrofuran, 3-propylsydnone, sulfur dioxide, phosphoryl chloride, thionyl chloride, sulfuryl chloride or mixed solutions of these compounds may be used. Moreover, an ionic solution may also be used.

The solvents are preferably dewatered by using, for example, activated alumina, molecular sieves, phosphorous pentaoxide or calcium chloride, or if allowable for the solvent, distilled in the presence of an alkali metal in an inert gas atmosphere to remove impurities and to dewater. The concentration of the electrolyte in the electrolyte solution prepared by dissolving the electrolyte in the solvent is preferably in a range from 0.5 to 3.0 mol/l to obtain a high ion conductivity.

Also, it is preferable to add a vinyl monomer which tends to carry out an electropolymerization reaction to the electrolyte solution to restrain the reaction between the electrode and the electrolyte solution. The addition of the vinyl monomer to the electrolyte solution ensures the formation of a polymer film having the functions of SEI (Solid Electrolyte Interface) or a protective film (passivating film) by the charge reaction of the battery, to thereby lengthen the charge/discharge cycle life. When the amount of the vinyl monomer to be added to the electrolyte solution is too small, the aforementioned effect is not obtained, whereas when the amount of the vinyl monomer is too large, the ion conductivity of the electrolyte solution is reduced and the thickness of the polymer film to be formed during charging is increased, which increases the resistance of the electrode. Therefore, the amount of the vinyl monomer in the electrolyte solution is preferably in a range from 0.5 to 5% by weight.

Preferable examples of the vinyl monomer include styrene, 2-vinylnaphthalene, 2-vinylpyridine, N-vinyl-2-pyrrolidone, divinyl ether, ethyl vinyl ether, vinyl phenyl ether, methylmethacrylate, methylacrylate, acrylonitrile and vinylene carbonate. More preferable examples of the vinyl monomer include styrene, 2-vinylnaphthalene, 2-vinylpyridine, N-vinyl-2-pyrrolidone, divinyl ether, ethyl vinyl ether, vinyl phenyl ether and vinylene carbonate. When the vinyl monomer has an aromatic group, it is preferable because the aromatic group has high affinity to lithium ions. It is also preferable to use the vinyl monomer having an aromatic group in combination with, for example, N-vinyl-2-pyrrolidone, divinyl ether, ethyl vinyl ether, vinyl phenyl ether or vinylene carbonate which has high affinity to the solvent of the electrolyte.

In order to prevent the leakage of the electrolyte solution, it is preferable to use a solid electrolyte or a solidified electrolyte. Examples of the solid electrolyte include glasses such as oxides consisting of a lithium element, silicon element, oxygen element, phosphorous element or sulfur element, and polymer complexes of organic polymers having an ether structure. As the solidified electrolyte, those obtained by gelling the above mentioned electrolyte solutions by a gelling agent to solidify the electrolyte solution are preferable. As the gelling agent, it is desirable to use a polymer which is swollen when it absorbs a solvent of the electrolyte solution and a porous material such as silica gel which absorbs a large amount of a liquid. As the polymer, a polyethylene oxide, polyvinyl alcohol, polyacrylonitrile, polymethylmethacrylate, vinylidene fluoride/hexafluoropropylene copolymer may be used. The polymer more preferably has a crosslinking structure.

The separator which is a support material of the electrolyte solution used as the ion conductor serves to prevent the developments of short circuits caused by the direct contact between negative electrode 401 and the positive electrode 403 in the electric energy storage device. The separator is required to have many pores allowing lithium ions to move and to be insoluble in the electrolyte solution and stable. Therefore, as the separator, materials having a micropore structure or nonwoven fabric structure, for example, films of glass, polyolefin such as a polypropylene and polyethylene, fluororesin, cellulose and polyimide having micropores are preferably used. Also, metal oxide films having micropores or resin films complicated with metal oxides may be used.

(Fabrication of an Electric Energy Storage Device)

The electric energy storage device of the present invention is fabricated by removing water thoroughly from the ion conductor 403, by stacking a negative electrode 401 and a positive electrode 402 with the ion conductor 403 being interposed therebetween to form an electrode group, by inserting this electrode group into a battery case 406 in a dry air or in a dry inert gas atmosphere where the dew temperature is sufficiently controlled, then by connecting each electrode with each electrode terminal and by sealing the battery case 406. When a microporous polymer film impregnated with the electrolyte solution is used as the ion conductor, a microporous polymer film is interposed as the separator for preventing the developments of short circuits between the negative electrode and the positive electrode to form an electrode group, which is then inserted into the battery case 406, each electrode is connected with each electrode terminal, the electrolyte solution is injected and then the battery case is sealed to fabricate a battery.

Shape and Structure of the Battery

Specific examples of the cell shape of the electric energy storage device of the present invention include a flat form, cylindrical form, rectangular form and sheet form. Also, examples of the structure of the cell include a monolayer type, multilayer type and spiral type. Among these types and forms, a spiral type cylindrical cell is characterized by the feature that because a negative electrode and a positive electrode are spiral wound with a separator being interposed therebetween, the electrode area can be increased so that large current can be made to flow across the negative electrode and positive electrode during charging/discharging. Also, a rectangular cell or sheet cell is characterized by the feature that the storage space of a device having a structure in which plural batteries are received can be efficiently utilized.

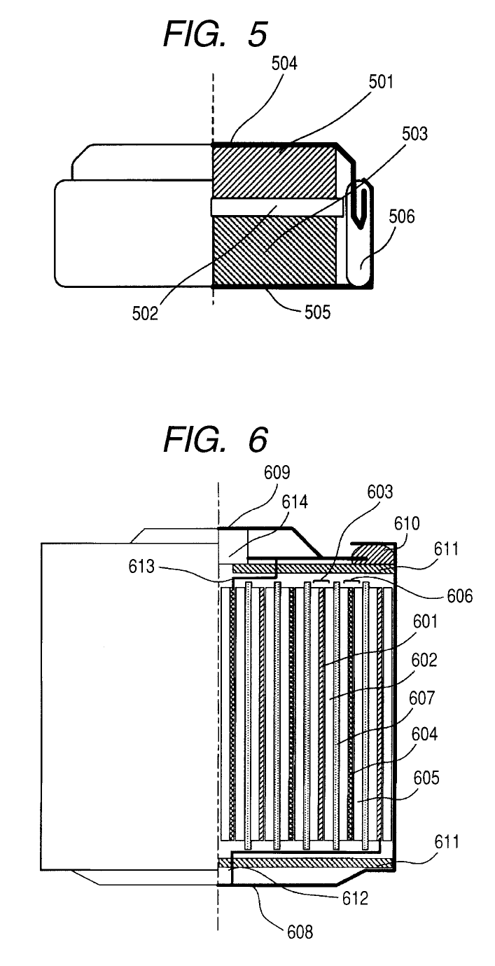

The shape and structure of the cell will be explained in more detail with reference to FIGS. 5 and 6. FIG. 5 shows a sectional view of a monolayer flat type (coin form) cell and FIG. 6 shows a sectional view of a spiral cylindrical type cell. Each of the above formed electric energy storage devices have the same fundamental structure shown in FIG. 4, which is provided with a negative electrode, a positive electrode, an ion conductor, battery case (battery housing) and output terminals.

In FIGS. 5 and 6, the symbols 501 and 603 represent a negative electrode, the symbols 503 and 606 represent a positive electrode, the symbols 504 and 608 represent a negative terminal (negative electrode cap or negative electrode can), the symbols 505 and 609 represent a positive terminal (positive electrode can or positive electrode cap), the symbols 502 and 607 represent an ion conductor, the symbols 506 and 610 represent a gasket, the symbol 601 represents a negative electrode current collector, the symbol 604 represents a positive electrode current collector, the symbol 611 represents an insulating plate, the symbol 612 represents a negative electrode lead, the symbol 613 represents a positive electrode lead and the symbol 614 represents a safety valve.

In the flat type (coin type) cell shown in FIG. 5, the positive electrode 503 containing a positive electrode material layer and the negative electrode 501 provided with a negative electrode material layer are stacked through the ion conductor 502 formed of, for example, a separator holding at least an electrolyte solution, this stacked one is received in the positive electrode can 505 as the positive terminal from the positive electrode side, and the negative electrode side of the stacked one is covered with the negative electrode cap 504 used as the negative terminal. Then, the gasket 506 is disposed in other parts of the positive electrode can.

In the spiral cylindrical type cell shown in FIG. 6, the positive electrode 606 provided with the positive electrode material layer (positive material layer) 605 formed on the positive electrode current collector 604 and the negative electrode 603 provided with the negative electrode active material layer (negative material layer) 602 formed on the negative electrode current collector 601 are faced to each other through the ion conductor 607 formed of, for example, a separator holding at least an electrolyte solution. The both electrodes are made into a coil having many turns to form a stacked one having a cylindrical structure.

The stacked electrodes having a cylindrical structure is received in the negative electrode can 608 used as the negative terminal. Also, the positive electrode cap 609 as the positive terminal is formed on the opening part side of the negative electrode can 608 and the gasket 610 is arranged in other parts of the negative electrode can. The stacked electrodes having a cylindrical structure is spaced apart from the positive electrode cap side through the insulating plate 611. The positive electrode 606 is connected with the positive electrode cap 609 through the positive electrode lead 613. Also, the negative electrode 603 is connected with the negative electrode can 608 through the negative electrode lead 612. The safety valve 614 used to adjust the internal pressure in the battery is put in the positive electrode cap side. The aforementioned electrode structure according to the present invention is used as the negative electrode 603.

An example of a method of fabricating the electric energy storage device shown in FIG. 5 or 6 will be explained.

(1) The separator (502, 607) is interposed between the negative electrode (501, 603) and the molded positive electrode (503, 606), which are then incorporated into the positive electrode can (505) or the negative electrode can (608).

(2) After the electrolyte solution is injected, the negative electrode cap (504) or the positive electrode cap (609) and the gasket (506, 610) are arranged.

(3) The material arranged in the (2) is caulked to complete an electric energy storage device.

In this case, the processes including the preparations of the materials of the electric energy storage device mentioned above and the fabrication of the battery are desirably carried out in dry air from which water is perfectly removed or in dry inert gas.

The members constituting the electric energy storage device as mentioned above will be explained.

(Gasket)

As the material of the gasket (506, 610), for example, fluororesins, polyolefin resins, polyamide resins, polysulfone resins and various rubbers may be used. As the method of sealing the electric energy storage device, methods using a glass seal tube or an adhesive, welding and soldering are used besides the “caulking” using a gasket as shown in FIGS. 5 and 6. Also, as the material of the insulating plate (611) shown in FIG. 6, various organic resin materials and ceramics are used.

(External Can)

The external can of the battery includes the positive electrode can or negative electrode can (505, 608) of the electric energy storage device, and the negative electrode cap or positive electrode cap (504, 609). As the material of the external can, stainless steel is preferably used. As other materials of the external can, an aluminum alloy, titanium clad stainless material, copper clad stainless material, nickel plating steel plate and the like are used frequently.

Because the positive electrode can (605) in FIG. 5 and the negative electrode can (608) in FIG. 6 each double as the case (electric energy storage device housing) and the terminal, the stainless steel is preferable. However, in the case where the positive electrode can or negative electrode can does not double as the electric case and the terminal, metals such as zinc, plastics such as a polypropylene, composite materials of plastic and a metal or glass fibers, or films prepared by laminating a plastic film on a metal foil such as aluminum may be used besides the stainless steel as the material of the battery case.

(Safety Valve)

The electric energy storage device is provided with a safety valve as a safety measures taken when the internal pressure in the electric energy storage device is increased. As the safety valve, for example, a rubber, spring, metal ball or rupture foil may be used.

### EXAMPLES

The present invention will be explained in more detail in examples.

Production of a negative electrode structure of the electric energy storage device

Examples of the production of the negative electrode structure of the electric energy storage device will be given below.

100 parts by weight of a silicon powder having an average particle size of 0.14 μm which was obtained by milling metal silicon (purity: 99%) by using a wet beads mill, 70 parts by weight of artificial graphite having an average particle size of 5 μm, and 3 parts by weight of acetylene black were mixed at 300 rpm for 20 min in a planetary ball mill using agate balls. Then, 132 parts by weight of a N-methyl-2-pyrrolidone solution containing 15% by weight (on solid basis) of each of the binders A1 to A8 and B1 to B3 as shown in Table 1 and 130 parts by weight of N-methyl-2-pyrrolidone were added to the obtained mixture, which was then mixed at 300 rpm for 10 min by a planetary ball mill to prepare a slurry for forming an electrode material layer.

The obtained slurry was applied to a copper foil having a thickness of 10 μm by an applicator, then dried at 110° C. for 0.5 hr and further dried at 200° C. under reduced pressure for 12 hr. Then, the thickness and density of the coating layer were adjusted by a roll press machine to obtain an electrode structure in which an electrode material layer having a thickness of 20 μm and a density of about 1.3 g/cm³ was formed on the copper foil current collector.

In this case, A1 to A8 and B1 to B3 as shown in Table 1 were used as the binder. Also, the breaking strength, tensile modulus, break elongation and the ratio of breaking strength/break elongation and glass transition temperature Tg of each binder are shown together in Table 1. The values of these mechanical properties were measured using sample films which were respectively heat-treated at a temperature lower by 50° C. than the glass transition temperature thereof according to the method described in the foregoing JIS K7161-1994 and K6782. Here, the binders A1, A2, A3, A4, A5, A8 and B2, and B3 are a polyamide imide. The binders A6 and A7 are a polyimide and the binder B1 is a silicon-modified polyamide imide.

TABLE 1

| | | | | Ratio of | Glass |
|---|---|---|---|---|---|
| | | | | breaking | transition |
| | Breaking | Tensile | Break | strength/ | temper- |
| Binder | strength/ | modulus/ | elongation/ | break | ature |
| name | Mpa | Mpa | % | elongation | Tg/° C. |
| A1 | 376 | 3300 | 67 | 5.61 | 280 |
| A2 | 121 | 3100 | 51 | 2.37 | 270 |
| A3 | 157 | 3400 | 109 | 1.44 | 270 |
| A4 | 210 | 3000 | 110 | 1.91 | 290 |
| A5 | 110 | 2800 | 60 | 1.83 | 300 |
| A6 | 196 | 3730 | 100 | 1.96 | 270~280 |
| A7 | 392 | 8830 | 30 | 13.07 | 300 |
| A8 | 114 | 2100 | 53 | 2.15 | 250 |
| B1 | 122 | 1310 | 22 | 5.55 | 254 |
| B2 | 27 | 900 | 33 | 0.82 | 80 |
| B3 | 43 | 100 or less | 250 | 0.17 | 140 |

In this case, the electrode material layer may be formed on the copper foil by using an electrospinning machine, by applying a high voltage across the copper foil as the current collector and the nozzle of the electrospinning machine, after the viscosity of the slurry obtained in the procedures was adjusted.

Evaluation of the amount of lithium to be electrochemically inserted into the negative electrode structure of the electric energy storage device

The evaluation of the amount of lithium to be electrochemically inserted into the negative electrode structure of the electric energy storage device was made in the following procedures.

Each of the electrode structures produced in the method was cut into a predetermined size and a nickel ribbon lead was connected with the electrode structure by spot welding to use the electrode structure, though originally used as a negative electrode for an electric energy storage device, as a working electrode (positive electrode). Metal lithium was combined as a counter electrode (negative electrode) to the produced electrode to make a cell and the amount of lithium to be electrochemically inserted into the working electrode was evaluated.

In this case, the nickel ribbon lead was connected by spot welding. A metal lithium foil having a thickness of 140 μm was bonded under pressure to a copper foil with one surface being roughened to make the lithium electrode.

The evaluation cell was made in the following procedures. A 17-μm-thick polyethylene film which had a microporous structure having a thickness of 17 μm and a porosity of 40% was interposed as the separator between each electrode made from the electrode structures and the lithium electrode in a dry atmosphere having a dew point of −50° C. or less. Then, the stacked electrode (working electrode)/separator/lithium electrode (counter electrode) was inserted into a battery case obtained by forming a pocket-like case from an aluminum laminate film having a polyethylene/aluminum foil/nylon structure, an electrolyte solution was added dropwise, and then, the laminate film of the opening part of the battery case was thermally fused in the condition that the leads were drawn out of the battery case to make an evaluation cell. As the electrolyte solution, in this case, a solution obtained by dissolving 1 M (mol/l) of lithium hexafluorophosphate (LiPF₆) in a solvent prepared by mixing ethylene carbonate and diethyl carbonate from which water was sufficiently removed in a ratio by volume of 3:7 was used.

The amount of lithium to be electrochemically inserted into the electrode was evaluated using the lithium electrode of the cell as the negative electrode and each working electrode to be made as the positive electrode in the following manner: the cell was made to discharge until the voltage of the cell reached 0.01 V and then to charge until the voltage of the cell reached 1.80 V. Specifically, the quantity of electricity to be discharged was defined as the quantity of electricity utilized to insert lithium and the quantity of electricity to be charged was defined as the quantity of electricity utilized to emit lithium.

Evaluation of Li-Insertion/Emission of the Electrode

A charge/discharge operation was repeated 50 times under a current of 1.60 mA/cm² to evaluate the Li-insertion/emission of the electrode made of various binder by the amount of Li (quantity of electricity) to be inserted at the 1st cycle, the amount of Li (quantity of electricity) to be emitted at the 1st cycle, the ratio (%) of the amount of Li to be emitted from the electrode to the amount of Li to be inserted into the electrode at the first cycle, the ratio of the amount of Li (quantity of electricity) to be emitted at the 10th cycle to that at the 1st cycle and the ratio of the amount of Li (quantity of electricity) to be emitted at the 50th cycle to that at the 10th cycle.

The types of binders used in Examples 1 to 8 and Comparative Examples 1 to 3 and the results of the evaluation are shown together in Table 2.

TABLE 2

| | | 1st Li- | 1st Li- | 1st Li- | | |
|---|---|---|---|---|---|---|
| | Binder to | insertion | emission | emission/insertion | Li-emission | Li-emission |
| | be used | mAh/g | mAh/g | (%) | 10th/1st | 50th/10th |
| Example 1 | A1 | 660 | 446 | 67.6% | 0.58 | 0.90 |
| Example 2 | A2 | 621 | 371 | 59.7% | 0.55 | 1.02 |
| Example 3 | A3 | 468 | 255 | 54.5% | 0.58 | 0.99 |
| Example 4 | A4 | 615 | 382 | 62.1% | 0.53 | 0.73 |
| Example 5 | A5 | 692 | 435 | 62.9% | 0.64 | 0.96 |
| Example 6 | A6 | 687 | 512 | 74.5% | 0.77 | 0.90 |
| Example 7 | A7 | 597 | 442 | 74.0% | 0.74 | 0.93 |
| Example 8 | A8 | 749 | 441 | 58.9% | 0.48 | 0.86 |
| Comparative | B1 | 413 | 220 | 53.3% | 0.41 | 0.89 |
| Example 1 | | | | | | |
| Comparative | B2 | 0 | 0 | 0.0% | 0.00 | 0.00 |
| Example 2 | | | | | | |
| Comparative | B3 | 0 | 0 | 0.0% | 0.00 | 0.00 |
| Example 3 | | | | | | |

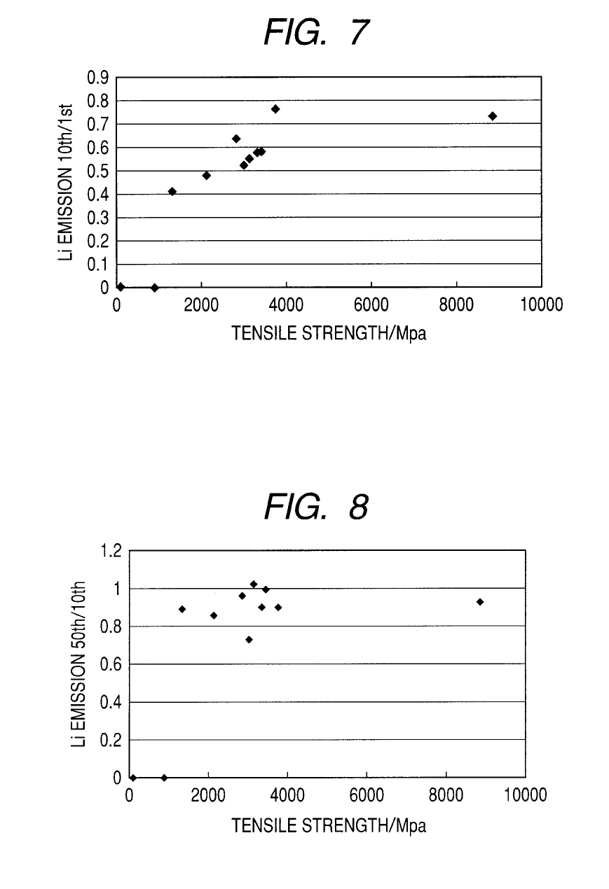

FIGS. 7 and 8 show graphs obtained by plotting so as to show the relations between the tensile modulus of each binder and the ratio of the amount of Li (quantity of electricity) to be emitted at the 10th cycle to that at the 1st cycle and between the tensile modulus of each binder and the ratio of the amount of Li (quantity of electricity) to be emitted at the 50th cycle to that at the 10th cycle.

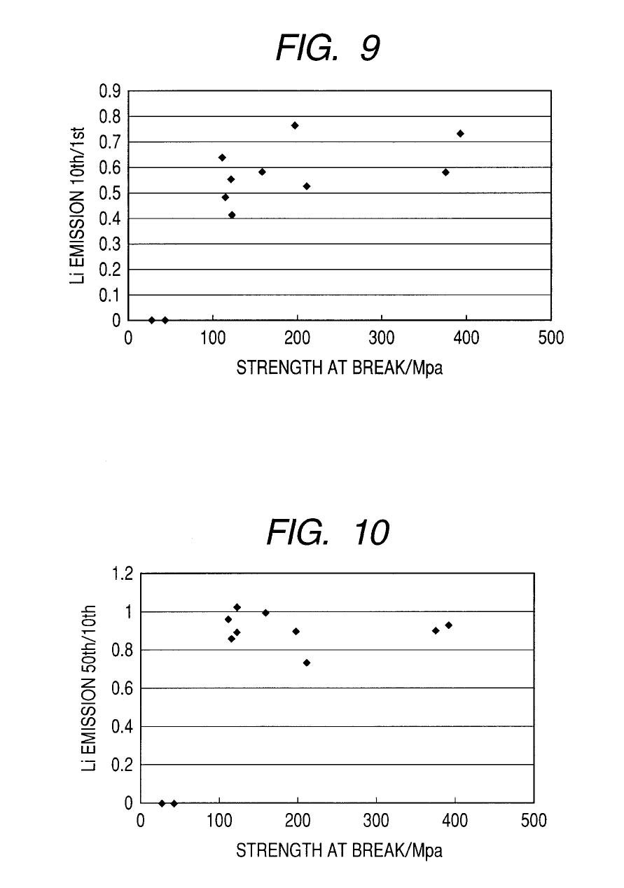

FIGS. 9 and 10 show graphs obtained by plotting so as to show the relations between the breaking strength of each binder and the ratio of the amount of Li (quantity of electricity) to be emitted at the 10th cycle to that at the 1st cycle and between the breaking strength of each binder and the ratio of the amount of Li (quantity of electricity) to be emitted at the 50th cycle to that at the 10th cycle.

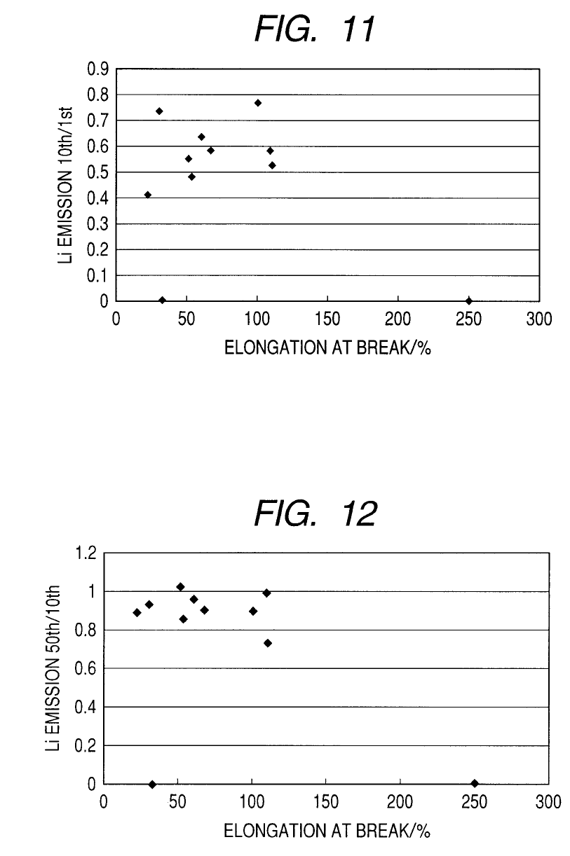

FIGS. 11 and 12 show graphs obtained by plotting so as to show the relations between the break elongation of each binder and the ratio of the amount of Li (quantity of electricity) to be emitted at the 10th cycle to that at the 1st cycle and between the break elongation of each binder and the ratio of the amount of Li (quantity of electricity) to be emitted at the 50th cycle to that at the 10th cycle.

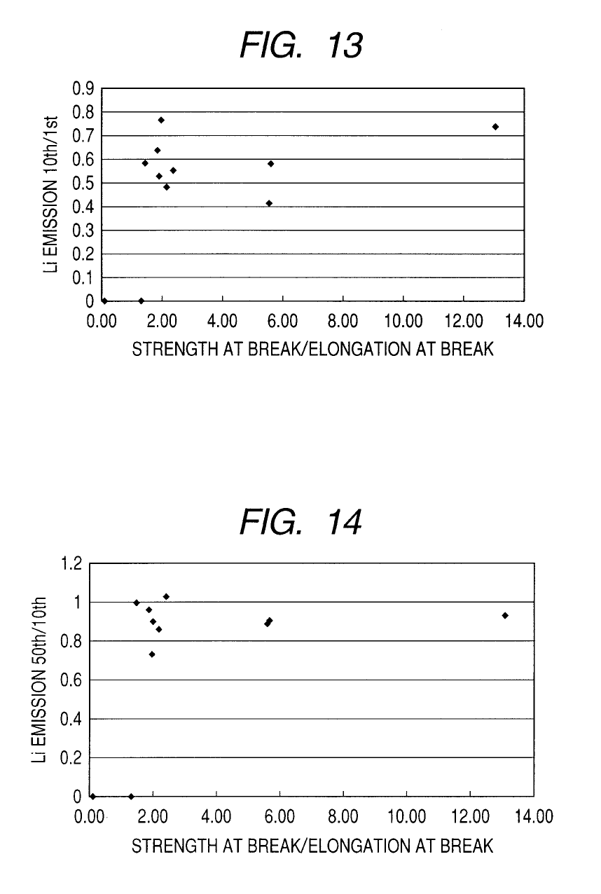

FIGS. 13 and 14 show graphs obtained by plotting so as to show the relations between the ratio of the breaking strength/break elongation of each binder and the ratio of the amount of Li (quantity of electricity) to be emitted at the 10th cycle to that at the 1st cycle and between the ratio of the breaking strength/break elongation of each binder and the ratio of the amount of Li (quantity of electricity) to be emitted at the 50th cycle to that at the 10th cycle.

When, as shown in FIGS. 7 and 8, the tensile modulus is 2000 MPa or more, the ratio of 10th Li-emission/1st Li-emission and the ratio of 50th Li-emission/10th Li-emission are particularly large, showing the development of the effects of the present invention.

When, as shown in FIGS. 9 and 10, the breaking strength is 100 MPa or more, the ratio of 10th Li-emission to 1st Li-emission and the ratio of 50th Li-emission to 10th Li-emission are particularly large, showing the development of the effects of the present invention.

When, as shown in FIGS. 11 and 12, the break elongation is 20 to 120%, the ratio of 10th Li-emission/1st Li-emission and the ratio of 50th Li-emission/10th Li-emission are particularly large, showing the development of the effects of the present invention.

When, as shown in FIGS. 13 and 14, the ratio of the breaking strength/break elongation is 1.4 MPa/% or more, the ratio of 10th Li-emission/1st Li-emission and the ratio of 50th Li-emission/10th Li-emission are particularly large, showing the development of the effects of the present invention.

### Example 9

Next, a different embodiment according to the present invention, that is, an example showing the effect according to the content of the binder will be shown.

### 1. Production of a Negative Electrode

(1) Preparation of a Negative Electrode Active Material

A high-frequency (RF) induction coupling heat plasma generator which was constituted of a reactor with which a heat plasma torch and a vacuum pump were connected was used. First, the reactor was vacuumized by a vacuum pump, 200 l/min of argon gas and 10 l/min of hydrogen gas were made to flow as the plasma gas. Pressure in the reactor was controlled to 50 kPa and 80 kW electric power with 4 kHz high frequency RF electric field was applied to the inductive coil to generate a plasma. Then, a powder raw material prepared by blending 90 parts by weight of a silicon powder having an average particle size of 4 μm with 10 parts by weight of metal aluminum having an average particle size of 1 μm was supplied to the inside of a heat plasma at a feed rate of about 500 g/hr by using 15 l/min argon gas as the carrier gas to obtain a micropowder material after predetermined reaction time passed. Then, the application of the high-frequency power was stopped, the introduction of the plasma generating gas was stopped, the reaction product was gradually oxidized and then nanoparticles were taken out.

The gradual oxidation was carried out by flowing argon gas having a purity of 999.99% and containing oxygen as impurities into the reactor. When the obtained nanoparticles were measured by TEM analysis, primary particles provided with amorphous surface layer of 1 nm to 10 nm in thickness on the surface layer of crystal silicon having a diameter of 20 nm to 200 nm were observed in a large part of them though fibrous part was observed in a part of them. As a result of EDX analysis of TEM, it was found that aluminum oxide was formed on the surfaces of the nanoparticles.

(2) Production of a Negative Electrode

100 parts by weight of each prepared complex powder, parts by weight of artificial graphite having an average particle size of 5 μm and 3 parts by weight of acetylene black were mixed at 300 rpm for 20 min in a planetary ball mill using agate balls. Then, 132 parts by weight of a N-methyl-2-pyrrolidone solution containing 10% by weight of the polyimide used as A6 rated as a good one in the studies concerning the binder and 195 parts by weight of N-methyl-2-pyrrolidone were added to the obtained mixture, which was then mixed at 300 rpm for 10 min by a planetary ball mill to prepare a slurry for forming an electrode material layer. Also, another slurry was prepared in the same manner as above except that a N-methyl-2-pyrrolidone solution containing 15% by weight of polyimide which was the binder A6 was used. The obtained two types of slurries were respectively applied to a copper foil of 10 μm in thickness by an applicator, then dried at 110° C. for 0.5 hr and further dried at 220° C. under reduced pressure. Then, the thickness and density of the coating layer were adjusted by a roll press machine to obtain an electrode structure in which an electrode material layer having a thickness range from 20 μm to 40 μm and a density range from 0.9 to 1.9 g/cm³ was formed on the copper foil current collector. The electrode structure was cut into a predetermined size and the nickel ribbon lead was connected with the electrode by spot welding to make an electrode (negative electrode) containing 10% by weight of the polyimide which was the binder A6 and an electrode (negative electrode) containing 15% by weight of the polyimide which was the binder A6.

In order to evaluate this electrode, the electrode which was to be originally used as the negative electrode of an energy storage device was used as a working electrode (positive electrode) and the same metal lithium that was used in Example 1 was used as a counter electrode (negative electrode) and were combined to make a cell, which was subjected to evaluation of the quantity of lithium to be inserted electrochemically.

Evaluation of Li-insertion/emission of the electrode

A charge/discharge operation was repeated 50 times under a current of 3.0 mA/cm² to evaluate the ratio of the amount of Li (quantity of electricity) to be emitted at the 10th cycle to that at the 1st cycle, to find that the ratio was 0.76 in the case of the electrode in which the content of the binder A6 was 10% by weight, whereas the ratio was 0.99 in the case of the electrode in which the content of the binder A6 was 15% by weight to show a significant improvement. Also, the ratio of the amount of Li (quantity of electricity) to be emitted at the 50th cycle to that at the 1st cycle was evaluated, to find that the ratio in the case of using the electrode in which the content of the binder A6 was 15% by weight was about 2.4 times that in the case of using the electrode in which the content of the binder A6 was 10% by weight.

### Example 10

Next, an example of a production of an electric energy storage device is shown below.

(1) Preparation of a Negative Electrode Active Material

A high-frequency (RF) inductively coupled heat plasma generator which was constituted of a reactor with which a heat plasma torch and a vacuum pump were connected was used. First, the reactor was vacuumized by a vacuum pump, 200 l/min of argon gas and 10 l/min of hydrogen gas were made to flow as the plasma gas. Pressure in the reactor was controlled to 50 kPa, and 80 kW electric power with 4 kHz frequency electric field was applied to the inductive coil to generate a plasma. Then, a powder raw material prepared by blending 90 parts by weight of a silicon powder having an average particle size of 4 μm with 10 parts by weight of metal aluminum having an average particle size of 1 μm was supplied to inside of the heat plasma at a feed rate of about 500 g/hr by using 15 l/min argon gas as the carrier gas, to thereby obtain a micropowder material after predetermined reaction time passed. Then, the application of the high-frequency power supply was turned off, the introduction of the plasma generating gas was stopped and the reaction product was gradually oxidized, and then nanoparticles were taken out.

In this case, the gradual oxidation was carried out by flowing argon gas having a purity of 999.99% and containing oxygen as impurities into the reactor. When the obtained nanoparticles were measured by TEM analysis, primary particles provided with amorphous surface layer of 1 nm to 10 nm in thickness on the surface layer of crystal silicon having a diameter of 20 nm to 200 nm were observed in a large part of them though fibrous part was observed in a part of them. As a result of EDX analysis of TEM, it was found that aluminum oxide was formed on the surfaces of the nanoparticles.

(2) Production of a Negative Electrode

100 parts by weight of each prepared complex powder, parts by weight of artificial graphite having an average particle size of 5 μm and 3 parts by weight of acetylene black were mixed at 300 rpm for 20 min in a planetary ball mill using agate balls. Then, 132 parts by weight of a N-methyl-2-pyrrolidone solution containing 15% by weight of the polyimide used as A6 rated as a good one in the studies concerning the binder and 195 parts by weight of N-methyl-2-pyrrolidone were added to the obtained mixture, which was then mixed at 300 rpm for 10 min by a planetary ball mill to prepare a slurry for forming an electrode material layer. The obtained slurry was applied to a copper foil of 10 μm in thickness by an applicator, then dried at 110° C. for 0.5 hr and further dried at 220° C. under reduced pressure. Then, the thickness and density of the coating layer were adjusted by a roll press machine to obtain an electrode structure in which an electrode material layer having a thickness range from 20 μm to 40 μm and a density range from 0.9 to 1.9 g/cm³ was formed on the copper foil current collector. The obtained electrode structure was cut into a predetermined size and a nickel ribbon lead was connected to the electrode by spot welding to make an electrode (negative electrode).

(3) Production of a Positive Electrode

100 parts by weight of a lithium nickel-cobalt-manganate (LiNi_{1/3}CO_{1/3}Mn_{1/3}O₂ powder) and 4 parts by weight of acetylene black were mixed at 300 rpm for 10 min in a planetary ball mill using agate balls. Then, 50 parts by weight of a N-methyl-2-pyrrolidone solution containing 10% by weight of a polyvinylidene fluoride and 50 parts by weight of N-methyl-2-pyrrolidone were added to the obtained mixture, which was then mixed at 300 rpm for 10 min by a planetary ball mill to prepare a slurry for forming an electrode material layer.

The obtained slurry was applied to an aluminum foil of 14 μm in thickness by a coater, then dried at 110° C. for 1 hr and further dried at 150° C. under reduced pressure. Then, the thickness of the coating layer was adjusted by a roll press machine to obtain an electrode structure in which an electrode material layer having a thickness of 82 μm and a density of 3.2 g/cm³ was formed on the aluminum foil current collector.

The obtained electrode structure was cut into a predetermined size and an aluminum ribbon lead was connected to the electrode by ultrasonic welding to make a LiNi_{1/3}CO_{1/3}Mn_{1/3}O₂ electrode (positive electrode).

(4) Production of an Electric Energy Storage Device

The electric energy storage device was all fabricated in a dry atmosphere where water content was so controlled that the dew point was −50° C. or less.

A separator was interposed between the negative electrode and the positive electrode, and an electrode group of the negative electrode/separator/positive electrode was inserted into a battery case obtained by forming a pocket-like case from an aluminum laminate film having a polyethylene/aluminum foil/nylon structure and an electrolyte solution was injected. Then, electrode leads were drawn out of the battery case, which was then heat-sealed to make an evaluation battery limited in the capacity of the positive electrode. The outside and inside of the aluminum laminate film are to be coated with the nylon film and polyethylene film respectively.

Also, for example, a microporous polyethylene film having a thickness of 17 μm was used as the separator.

As the electrolyte solution, in this case, an electrolyte solution prepared in the following manner was used. First, ethylene carbonate and diethyl carbonate from which water was sufficiently removed were mixed in a ratio by volume of 3:7 to prepare a solvent. Then, 1 M (mol/l) of lithium hexafluorophosphate (LiPF₆) was dissolved in the obtained solvent to prepare an electrolyte solution.

(Charge/Discharge Test)

Using the electric energy storage devices, each device was made to charge at a current density fixed to 0.48 mA/cm³ until the cell voltage reached 4.2 V, made to charge at a fixed voltage of 4.2 V, suspended for 10 min, then made to discharge at a current density fixed to 0.48 mA/cm³ until the cell voltage reached 2.7 V and suspended for 10 min. This charge/discharge cycle was repeated twice and then, charge/discharge operation was repeated at a current density of 1.6 mA/cm².

Also, the output of the electric energy storage device was varied in the discharge operation to measure the energy when the electric energy storage device was discharged until the cell voltage reached 2.7 V, to find that the energy density per volume of the obtained electric energy storage device was about 680 Wh/L and the power density per volume was about 5000 W/L.

As well as the polyimide A6 which was evaluated as a good one as the binder used above as the negative electrode binder of the electric energy storage device, an electric energy storage device using an electrode formed by using the polyimide A7 in place of the polyimide A6 and by treating at a heat treating temperature 180° C. exhibited almost the same performance as the electric energy storage device.

In order to make a long-life negative electrode, the ratio of the binder in the electrode layer was increased to 20% by weight (ratios of other active material and conductive auxiliary material were unchanged) in the operations for making the negative electrode as described in the (2) to make a negative electrode and the same procedures as those used in the electric energy storage device were carried out to make a device. Moreover, when acetylene black used as the conductive auxiliary material was increased such that the ratio of acetylene black/binder=1/2, the internal resistance of the obtained electric energy storage device was decreased and also exhibited the characteristics that it had high power density and high energy density, and also had a long charge/discharge repetitive life.

### Example 11

An electrode was made in the same manner as in Example 9 except that the slurry was applied to a copper foil and the drying condition after the slurry was dried at 110° C. for 0.5 hr was changed as follows.

a. Dried at 220° C. under reduced pressure. (same as that of Example 9)
b. Dried at 260° C. in a nitrogen flow.
c. Dried at 290° C. in a nitrogen flow.
d. Dried at 400° C. in a nitrogen flow.

In the a to d, a and b are dried at a temperature including and less than the glass transition temperature of the binder A6, and c and d are dried at a temperature exceeding the glass transition temperature of the binder A6. The reason why the drying except for that of a is carried out in a nitrogen flow is that it is difficult to perform high-temperature treatment under reduced pressure because of the restriction placed by the specification of the used heat-treating apparatus.

Evaluation of Li-Insertion/Emission of the Electrode

The electrode obtained in this manner was made to charge/discharge repetitively in two conditions of 1.6 mA/cm³ and 0.16 mA/cm³ to evaluate the initial and repetitive Li-insertion/emission characteristics.

The results are shown in the following Tables 3 and 4. In these tables, “Electrode treating temperature” means the drying temperature.

TABLE 3
Test results of repetitive Li-insertion/emission at a current density of 1.6 mA/cm²

| Electrode, | a | | | | b | | | | c | | | |
|---|---|---|---|---|---|---|---|---|---|---|---|---|
| Sample # | | | | | | | | | | | | |
| Electrode | 260(Under a N₂ flow) | | | | 290 (Under a N₂ flow) | | | | 400(Under a N₂ flow) | | | |
| treating | | | | | | | | | | | | |
| temperature | | | | | | | | | | | | |
| (° C.) | | | | | | | | | | | | |
| Thickness | 14 | | | | 19 | | | | 19 | | | |
| of the | | | | | | | | | | | | |
| electrode | | | | | | | | | | | | |
| layer (μm) | | | | | | | | | | | | |
| Density of | 1.43 | | | | 1.27 | | | | 1.18 | | | |
| the electrode | | | | | | | | | | | | |
| layer | | | | | | | | | | | | |
| (g/cm³) | | | | | | | | | | | | |
| | Li- | | | Li- | Li- | | | Li- | Li- | | | Li- |
| | inser- | | Li- | emission/ | inser- | | Li- | emission/ | inser- | | Li- | emission/ |
| | tion | Li- | emission/ | 1st Li- | tion | Li- | emission/ | 1st Li- | tion | Li- | emission/ | 1st Li- |
| | (mAh/ | emission | insertion | emission | (mAh/ | emission | insertion | emission | (mAh/ | emission | insertion | emission |
| cycle No. | g) | (mAh/g) | (%) | (%) | g) | (mAh/g) | (%) | (%) | g) | (mAh/g) | (%) | (%) |
| 1 | 579 | 326 | 56.3 | 100 | 670 | 412 | 61.5 | 100 | 819 | 530 | 64.8 | 100 |
| 50 | 365 | 360 | 98.5 | 110.4 | 415 | 409 | 98.6 | 99.2 | 355 | 350 | 98.8 | 66.1 |
| 100 | 317 | 311 | 98.2 | 95.5 | 309 | 304 | 98.3 | 73.8 | 304 | 299 | 98.2 | 56.4 |
| 110 | 307 | 301 | 98.2 | 92.5 | 286 | 282 | 98.6 | 68.4 | 268 | 264 | 98.6 | 49.8 |

TABLE 4
Test results of repetitive Li-insertion/emission at a current density of 0.16 mA/cm²

| | | |
|---|---|---|
| Electrode, Sample # | a | b |
| Electrode treating | 220 (Under reduced pressure) | 260(Under a N₂ flow) |
| temperature (° C.) | | |
| Thickness of the | 21 | 16 |
| electrode layer (μm) | | |
| Density of the | 1.33 | 1.31 |
| electrode layer | | |
| (g/cm³) | | |

| | | | | Li- | | | | Li- |
|---|---|---|---|---|---|---|---|---|
| | | | Li- | emission/ | | | Li- | emission/ |
| | Li- | Li- | emission/ | 1st Li- | Li- | Li- | emission/ | 1st Li- |
| | insertion | emission | insertion | emission | insertion | emission | insertion | emission |
| cycle No. | (mAh/g) | (mAh/g) | (%) | (%) | (mAh/g) | (mAh/g) | (%) | (%) |
| 1 | 1984 | 1728 | 87.1 | 100 | 1634 | 1273 | 77.9 | 100 |
| 5 | 1730 | 1681 | 97.2 | 97.3 | 1234 | 1214 | 98.4 | 95.4 |
| Electrode, Sample # | c | | | | d | | | |
| Electrode treating | 290(Under a N₂ flow) | | | | 400(Under a N₂ flow) | | | |
| temperature (° C.) | | | | | | | | |
| Thickness of the | 16 | | | | 16 | | | |
| electrode layer (μm) | | | | | | | | |
| Density of the | 1.32 | | | | 1.08 | | | |
| electrode layer | | | | | | | | |
| (g/cm³) | | | | | | | | |
| | | | | Li- | | | | Li- |
| | | | Li- | emission/ | | | Li- | emission/ |
| | Li- | Li- | emission/ | 1st Li- | Li- | Li- | emission/ | 1st Li- |
| | insertion | emission | insertion | emission | insertion | emission | insertion | emission |
| cycle No. | (mAh/g) | (mAh/g) | (%) | (%) | (mAh/g) | (mAh/g) | (%) | (%) |
| 1 | 1621 | 1254 | 77.3 | 100 | 1589 | 1237 | 77.9 | 100 |
| 5 | 1212 | 1186 | 97.9 | 94.6 | 1191 | 1175 | 98.6 | 94.9 |

From the results shown in Table 3, it is found that it makes a large difference in the cycle deterioration when the insertion/emission cycle is repeated about 100 times whether the treating temperature is higher or lower the glass transition temperature of the binder A6. Also, from the results shown in Table 3, it is found that the degree of a reduction in capacity caused by repetitive Li-insertion/Li-emission (charge/discharge) becomes smaller with a drop in treating temperature, showing a smaller deterioration in capacity.

Further, from the results shown in Table 4, it is found that in a charge/discharge operation at a low current density, the lower the electrode treating temperature is, the more the electrode according to the present invention is superior in all the initial amount of Li to be emitted, the ratio of the initial amount of Li to be emitted to the initial amount of Li to be inserted, and cycle deterioration from the 1st cycle to 5th cycle. Particularly, it is found that there is a large difference in these characteristics between the treating temperatures 260° C. and 220° C.

As is mentioned above, it is considered that the breakage of the electrode caused by the expansion and shrinkage of silicon or tin particles is reduced and also, the internal resistance can be reduced, by limiting the mechanical properties and baking temperature of the binder material which is one structural component in the electrode structure, with the result that an electrode structure which has a high power density and energy density and is also superior in, particularly, repetitive cycle characteristics, and an electric energy storage device utilizing the electrode structure can be provided.

### INDUSTRIAL APPLICABILITY

As is explained above, the present invention can provide an electric energy storage device which has a high power density, a high energy density and long repetitive life.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-149192, filed Jun. 23, 2009, which is hereby incorporated by reference herein in its entirety.

What is claimed is:

1. An electrode structure provided with an electrode material layer comprising an electrode material including active material particles containing at least one type selected from the group consisting of silicon, tin and alloys containing at least one of silicon and tin, and a binder which binds the active material particles, wherein the binder has the following characteristics: tensile modulus: 2000 MPa or more, breaking strength: 100 MPa or more, break elongation: 20% or more and 120% or less and the ratio of breaking strength/break elongation >1.4 (MPa/%), and the active material particles have an average particle size of 0.5 μm or less, the electrode structure being produced by baking the electrode material and having a maximum thermal history temperature less than 350° C. and lower than the glass transition temperature of the binder.

2. The electrode structure according to claim 1, wherein the electrode structure has a maximum thermal history temperature less than 250° C.

3. The electrode structure according to claim 1, wherein the average particle size of the active material particles is 0.2 μm or less.

4. The electrode structure according to claim 1, wherein the active material particles contains, as its structural element, plural primary particles containing at least one type selected from the group consisting of silicon, tin and alloys containing at least one of silicon and tin, the primary particle being constituted of a crystal particle which is provided with an amorphous surface layer having 1 nm or more and 10 nm or less in thickness and has a diameter of 5 nm or more and 200 nm or less, wherein the amorphous surface layer of the primary particle is constituted of at least a metal oxide, and Gibbs free energy produced when the metal constituting the metal oxide is oxidized is smaller than that produced when silicon or tin is oxidized, showing that the metal oxide is more thermodynamically stable than silicon oxide or tin oxide.

5. The electrode structure according to claim 4, wherein the metal constituting the metal oxide is Zr or Al.

6. The electrode structure according to claim 1, wherein the binder is a polyimide or polyamide imide.

7. An electric energy storage device comprising a negative electrode using the electrode structure according to any one of claims 1 to 6, a lithium ion conductor and a positive electrode, the device utilizing the oxidation reaction of lithium and the reducing reaction of lithium ions.
